(19) United States
(12) Patent Application Publication
(10) Pub. No.: US 2024/0266555 A1
(43) Pub. Date: Aug. 8, 2024

(54) NEGATIVE ELECTRODE SPACER FOR FLOW BATTERY

(71) Applicant: ESS TECH, INC., Wilsonville, OR (US)

(72) Inventor: Sean Casey, Oregon City, OR (US)

(21) Appl. No.: 18/412,269

(22) Filed: Jan. 12, 2024

Related U.S. Application Data
(60) Provisional application No. 63/483,203, filed on Feb. 3, 2023.

(51) Int. Cl. H01M 8/0221; H01M 4/86; H01M 4/88; H01M 4/90; H01M 4/96; H01M 8/0252; H01M 8/0258; H01M 8/18

(52) U.S. Cl. CPC H01M 8/0221; H01M 4/8652; H01M 4/88; H01M 4/9041; H01M 4/96; H01M 8/0252; H01M 8/0258; H01M 2004/8694; H01M 8/188

(57) ABSTRACT

Systems and methods are provided for an electrode assembly. In one example, the electrode assembly includes a bipolar plate and a negative electrode spacer fixedly coupled to a surface of the bipolar plate. The negative electrode spacer may comprise an array of discrete structures protruding from the surface of the bipolar plate.

### CROSS-REFERENCE TO RELATED APPLICATION

The present application claims priority to U.S. Provisional Application No. 63/483,203 entitled NEGATIVE ELECTRODE SPACER FOR FLOW BATTERY filed Feb. 3, 2023. The entire contents of the above identified application are hereby incorporated by reference for all purposes.

### FIELD

The present description relates generally to electrode assemblies for redox flow battery systems.

### BACKGROUND AND SUMMARY

Redox flow batteries are suitable for grid scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low cost, earth-abundant materials. The iron redox flow battery (IFB) relies on iron, salt, and water for electrolyte, thus comprising simple, earth abundant, and inexpensive materials and eliminates incorporation of harsh chemicals, thereby allowing the IFB to impose minimal negative impact on the environment.

An electrochemical cell of the IFB may include a positive electrode, a membrane separator, a negative electrode, and a bipolar plate, arranged in a stack. The bipolar plate is positioned between the negative electrode and a first face of the positive electrode and the membrane separator is positioned between a second, opposite face of the positive electrode and a negative electrode of an adjacent cell. The negative electrode may be configured as a spacer along a negative side of the bipolar plate to provide space, e.g., volume for electrolyte to flow therethrough, and may be formed as a separate component from the bipolar plate. As such, positioning of the negative electrode spacer along a surface of the bipolar plate is demanded during assembly of the electrochemical cell.

In some instances, the negative electrode spacer may be poorly aligned with the bipolar plate during placement or may not be positioned on the bipolar plate at all, due to operational errors. Non-optimal positioning or omission of the negative electrode spacer may lead to issues such as electrical shorting, insufficient compression of the positive electrode to moderate electrolyte flow therethrough, and poor battery performance. Furthermore, separate fabrication of the negative electrode spacer and associated time and labor demands for suitably positioning the negative electrode spacer on the bipolar plate may add to manufacturing costs.

In addition, when fabricated independently from the bipolar plate, the negative electrode spacer may be configured as a mesh with ribs extending along a direction of electrolyte flow across the bipolar plate. The ribs may partition a volume of a negative electrode compartment, formed in part by the bipolar plate and the negative electrode spacer, into discrete flow channels. Separation of the volume of the negative electrode compartment into the flow channels may impede homogeneous distribution of electrolyte across an active area of the bipolar plate. A plating quality, e.g., uniformity, thickness, and resistance to flaking of plated metal, achieved during charging of the IFB may be degraded, resulting in loss of capacity.

In one example, the issues described above may be at least partially addressed by an electrode assembly including a bipolar plate and a negative electrode spacer fixedly coupled to a surface of the bipolar plate, the negative electrode spacer comprising an array of discrete structures protruding from the surface of the bipolar plate. In this way, manufacturing of the battery cell may be simplified and production costs may be reduced while allowing for enhanced control over negative electrode spacer placement and associated effects on electrolyte flow.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system which may include a bipolar plate with a flow-optimized negative electrode spacer.

FIG. 2 shows a first example of a flow-optimized negative electrode spacer coupled to a bipolar plate.

FIG. 3 shows a detailed view of a portion of the flow-optimized negative electrode spacer of FIG. 2.

FIG. 4 shows a cross-sectional view of an electrode assembly configured with the flow-optimized negative electrode spacer of FIGS. 2-3.

FIG. 5 shows a second example of a flow-optimized negative electrode spacer coupled to a bipolar plate.

FIG. 6 shows a detailed view of a portion of the flow-optimized negative electrode spacer of FIG. 5.

FIG. 7 shows a third example of a flow-optimized negative electrode spacer coupled to a bipolar plate.

FIG. 8 shows an example of a method for fabricating an electrode assembly incorporating a flow-optimized negative electrode spacer.

FIG. 9 shows a graph illustrating an effect of a spacing and a diameter of pegs of the flow-optimized negative electrode spacer on an open area of a bipolar plate for plating.

FIG. 10 shows a graph illustrating an effect of a length and a width of pegs of the flow-optimized negative electrode spacer on an open area of a bipolar plate for plating.

### DETAILED DESCRIPTION

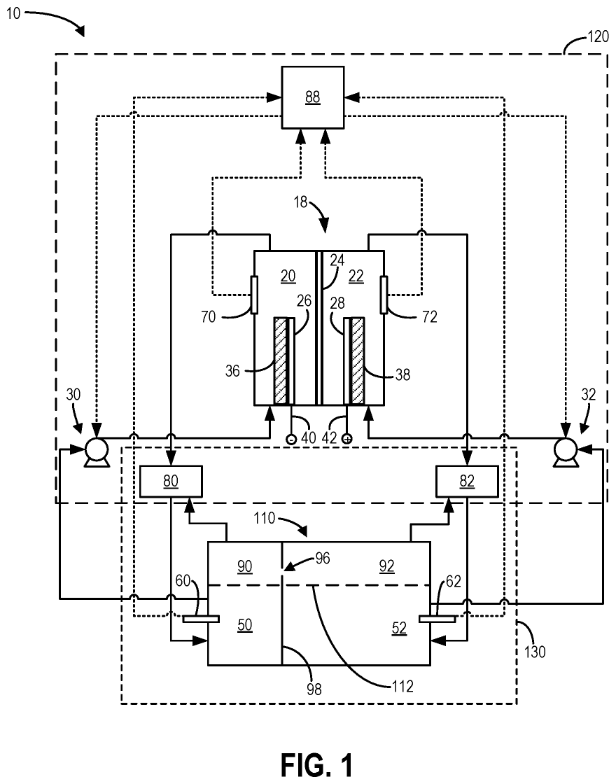

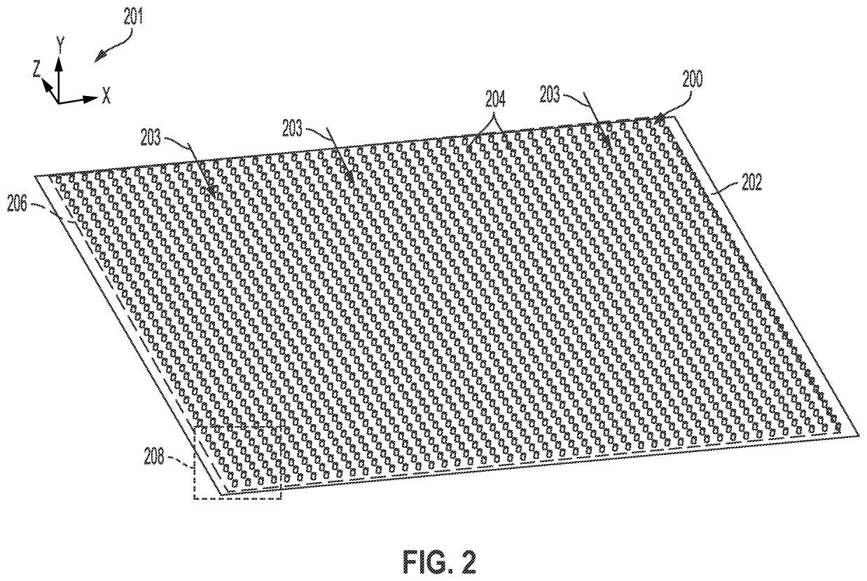

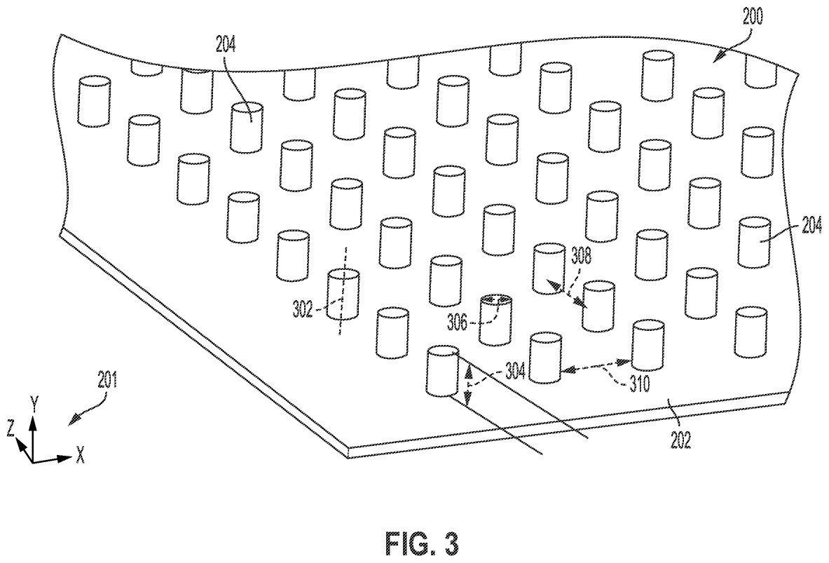

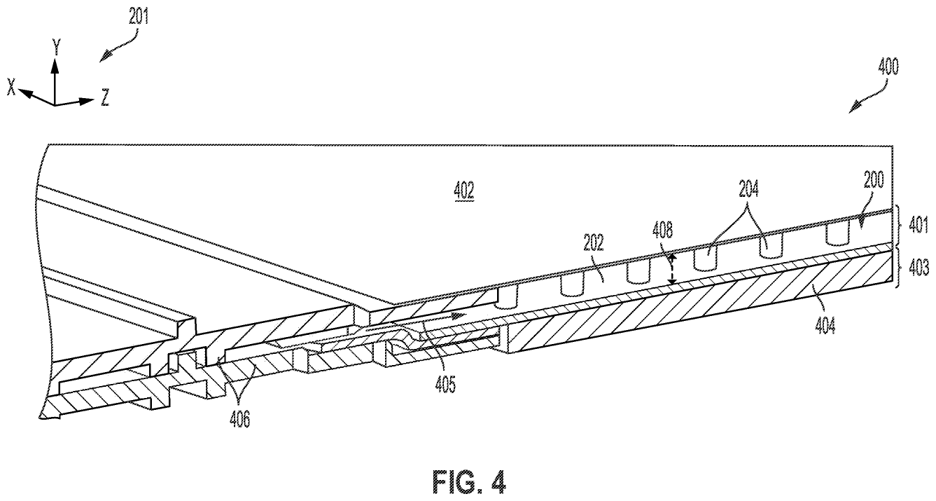

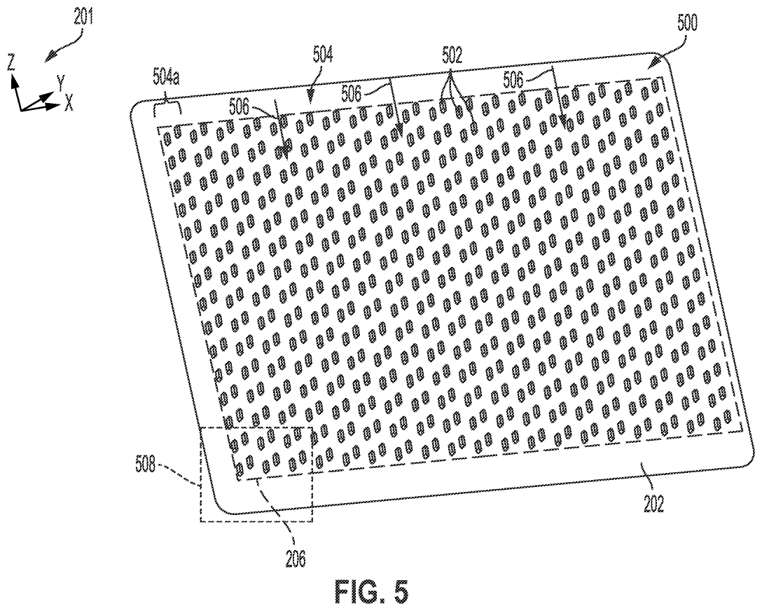

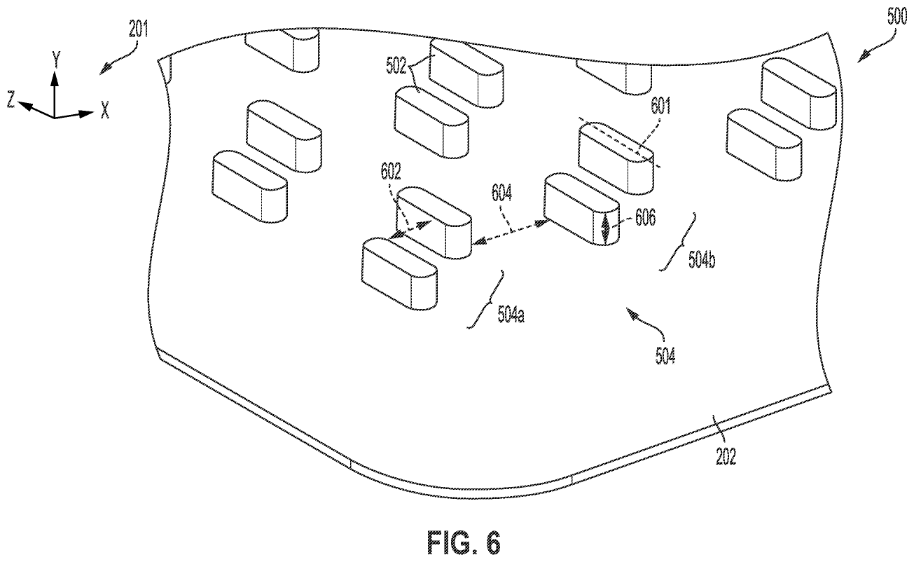

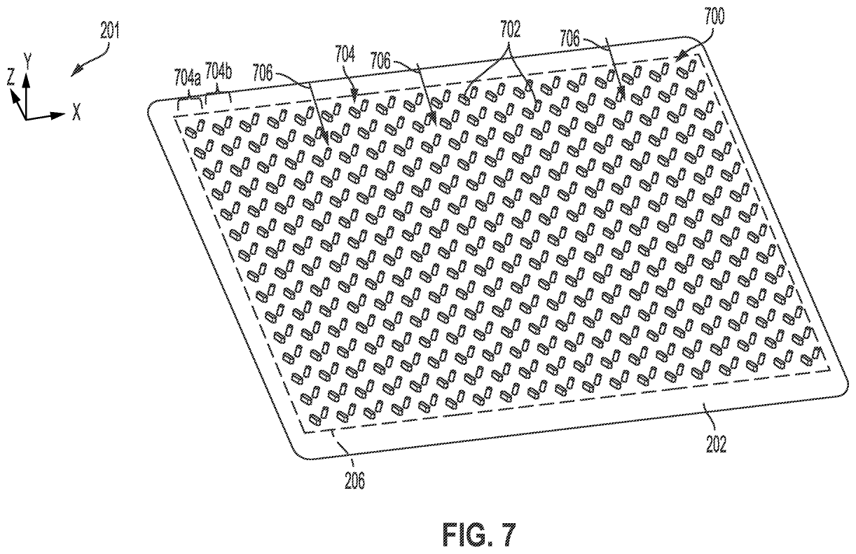

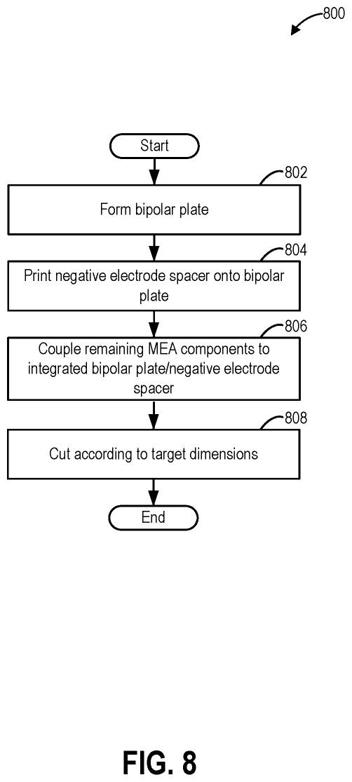

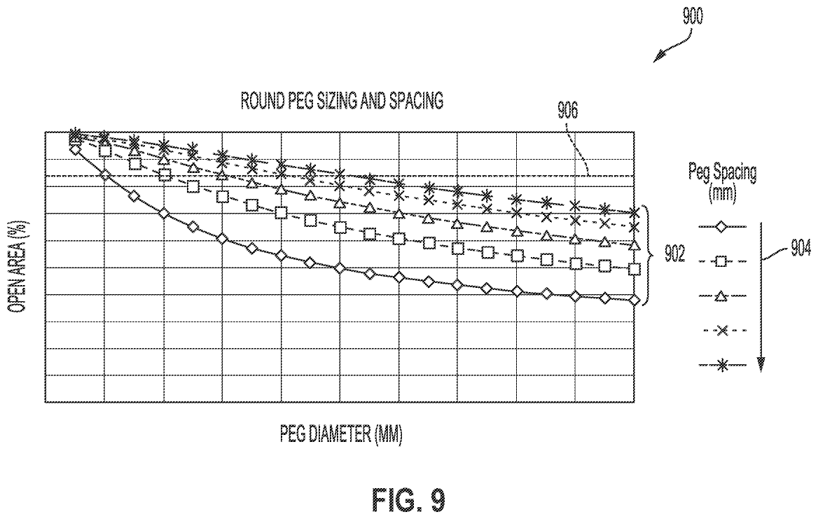

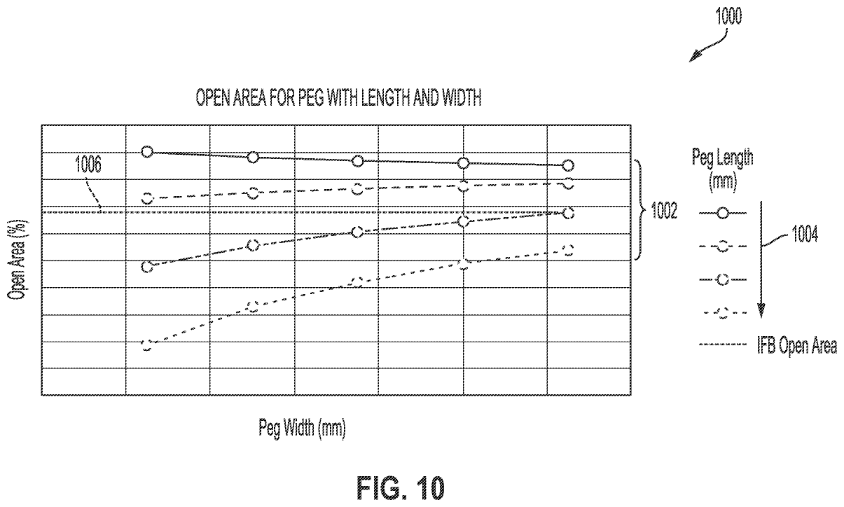

The following description relates to systems and methods for manufacturing a battery cell for a redox flow battery system. The redox flow battery system is shown in FIG. 1 with a battery cell having positive and negative electrode compartments separated by a membrane and including at least one bipolar plate. In some examples, a negative electrode of the battery cell may be configured as a spacer coupled to a surface of the bipolar plate and a geometry of the negative electrode may moderate flow of electrolyte through the negative electrode compartment. A first example of a negative electrode spacer with a geometry promoting optimized electrolyte flow, e.g., a flow-optimized negative electrode spacer, is shown in FIGS. 2 and 3, and depicted incorporated into an electrode assembly in FIG. 4. A second example of a flow-optimized negative electrode spacer having an alternative negative electrode spacer geometry is depicted in FIGS. 5-6, and a third example of a flow-optimized negative electrode spacer configured to increase lateral flow is illustrated in FIG. 7. An exemplary method for manufacturing an electrode assembly for the redox flow battery system is shown in FIG. 8, where the manufacturing includes incorporating a flow-optimized negative electrode spacer into the electrode assembly. Effects of dimensions and spacing of pegs of flow-optimized negative electrode spacers on an area available for plating at corresponding bipolar plates are illustrated in graphs in FIGS. 9 and 10.

Turning first to FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

$$\begin{matrix}{Fe}^{2 +} + 2 {e}^{-} ↔ {Fe}^{0} & - 0.44 V & ( negative electrode )\end{matrix} \qquad ( 1 )$$

$$\begin{matrix}{Fe}^{2 +} ↔ 2 {Fe}^{3 +} + 2 {e}^{-} & + 0.77 V & ( positive electrode )\end{matrix} \qquad ( 2 )$$

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fc²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese (II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions.

FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62.

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be pre-formed for battery cycling). As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

In some examples, a negative electrode, e.g., the negative electrode 26 of FIG. 1, of a battery cell may be configured as a spacer (e.g., a negative electrode spacer) arranged between a negative side of a bipolar plate (e.g., a side exposed to negative electrolyte in a negative electrode compartment of the battery cell) and a membrane separator of the battery cell. The negative electrode spacer may be in direct contact with each of the negative side of the bipolar plate and the membrane separator and may be formed of a relatively rigid material to maintain a space between the bipolar plate and the membrane separator, even upon compression of the battery cell.

Electrolyte may flow in the space maintained by the negative electrode spacer and a geometry and spacing of the negative electrode spacer may therefore affect electrolyte distribution through the negative electrode compartment. For example, arrangement of the negative electrode spacer to promote flow along a longitudinal axis of the bipolar plate may be desirable for facilitating redox reactions during operation of a redox flow battery system. In some examples, where the negative electrode spacer is fabricated as a separate unit from the bipolar plate, the geometry of the negative electrode spacer may be constrained to configurations that maintain a structural framework of the negative electrode spacer as a standalone structure. As one example, the negative electrode spacer may be configured as a mesh to allow for facile assembly of a battery cell including the bipolar plate and the negative electrode spacer.

When configured as the mesh, the negative electrode spacer may include a plurality of ribs defining electrolyte flow channels of the negative electrode compartment. The plurality of ribs, however, may occupy a volume of the negative electrode compartment, and block a portion of an active area of the bipolar plate that is undesirably high. In some instances, electrolyte flowing across the active area of the bipolar plate, the active area being a region of the bipolar plate where plating occurs during charging of a battery system, may not be evenly distributed amongst the flow channels. Exchange of electrolyte between the flow channels, however, is inhibited by the plurality of ribs. As a result, a plating uniformity across the active area of the bipolar plate and surfaces of the negative electrode spacer may be poor and power output of the battery system may be degraded.

In one example, a geometry of the negative electrode spacer may be modified to increase homogeneous flow distribution across the bipolar plate. Variations in the geometry that allow for increased lateral flow along the bipolar plate may be enabled by utilizing fabrication methods that directly couple the negative electrode spacer to a surface of the bipolar plate. Constraints that may otherwise be imposed on the negative electrode spacer geometry, when the negative electrode spacer is a separate, standalone unit, are thereby alleviated. For example, by forming the bipolar plate from a conductive thermoplastic composite, such as a carbon-based conductive material loaded with a thermoplastic polymer, a compatible nonconductive thermoplastic may be used to form the negative electrode spacer, which may be directly bonded (e.g., mechanically and chemically) to the bipolar plate.

As an example, the conductive material of the thermoplastic composite may be graphite and the thermoplastic polymer may be polypropylene. In other examples, however, the conductive material may include titanium, stainless steel, or any other conductive element or alloy while the thermoplastic polymer may be polyphenylene sulfide (PPS), polyphenylsulfone (PPSU), polyether ether ketone (PEEK), polytetrafluoroethylene (PTFE), or perfluororalkoxy alkane (PFA), amongst others. By forming the flow-optimized negative electrode spacer with a similar (e.g., with respect to material properties) thermoplastic polymer, the flow-optimized negative electrode spacer may be fixedly coupled to the bipolar plate via a low cost process. For example, the bipolar plate may first be extruded and then the flow-optimized negative electrode spacer may be additively manufactured (e.g., 3D printed) directly onto the bipolar plate. Alternatively, the flow-optimized electrode spacer may be extruded separately and welded onto the bipolar plate.

By fabricating the negative electrode spacer via a process that fixedly couples the negative electrode spacer to the bipolar plate surface, the negative electrode spacer may be formed as discrete structures that do not demand mechanical interconnection for structural stability. For example, the negative electrode spacer may be configured as an array of individual pegs, with each of the pegs bonded to the bipolar plate surface. A cumulative effect of the pegs on electrolyte flow may be determined based on a relative arrangement of the pegs. For example, a shape and size of the pegs, a spacing of the pegs, and an orientation of the pegs relative to one another, may be selected to impose desired effects on electrolyte distribution through the negative electrode compartment of an electrode assembly.

Further, in one example, equipment for additive manufacturing of the flow-optimized negative electrode spacer may be incorporated into a production assembly line, immediately after an extruder for forming the bipolar plate. Fabrication of the flow-optimized negative electrode spacer may thereby be seamlessly integrated into a manufacturing process of an electrode assembly including the bipolar plate and flow-optimized negative electrode spacer. By additively manufacturing the flow-optimized negative electrode spacer directly onto the bipolar plate, the manufacturing process may be streamlined, a flexibility of flow-optimized negative electrode spacer geometry may be increased to include a wide variety of configurations, and battery performance may be increased while maintaining costs low.

A first example of a flow-optimized negative electrode spacer 200 bonded (e.g., fixedly coupled) to a surface of a bipolar plate 202 is depicted in FIG. 2. A set of reference axes 201, indicating a y-axis, an x-axis, and a z-axis, is provided for comparison between views shown. In the examples illustrated in FIGS. 2-7, which are described in tandem herein, the z-axis is parallel with a direction of predominant electrolyte flow, although other orientations are possible. The surface of the bipolar plate 202 may be a negative side of the bipolar plate 202, which may be a side of the bipolar plate 202 that is included in a negative electrode compartment (e.g., negative electrode compartment 20 of FIG. 1) of a redox flow battery system, such as redox flow battery system 10 of FIG. 1. As described above, the bipolar plate 202 may be formed of a conductive thermoplastic composite, such as graphite loaded with polypropylene, and may be fabricated by extrusion or by injection molding. As an example, the bipolar plate 202 may be 30-40% polypropylene and 60-70% carbon, by weight.

The flow-optimized negative electrode spacer 200 comprises a plurality of pegs 204, which may be cylindrical structures protruding from the surface of the bipolar plate 202. A flat surface of each of the pegs 204 may be in face-sharing contact with the surface of the bipolar plate 202. A tubular section of a peg of the plurality of pegs may extend from the bipolar plate 202 to a second flat surface, thereby shaping a cylinder. A shape and size of each of the pegs may be identical. The pegs 204 may be oriented in uniform rows and columns such that flow paths parallel to the z-axis are shaped. Additionally or alternatively, the pegs 204 may be arranged in a quincunx formation or other formation that shapes flow paths angled to the z-axis.

In one example, as described above, the pegs 204 may be formed of a nonconductive thermoplastic polymer, such as polypropylene. Further, the flow-optimized negative electrode spacer 200 may be fabricated by additive manufacturing, such as 3D printing. The pegs 204 may be spaced apart evenly across an active area 206 of the bipolar plate 202, where the active area 206 may be a surface area of the bipolar plate 202 that is exposed to electrolyte. In other words, the active area 206 may be a surface area of the negative side of the bipolar plate 202 after subtracting an area occupied and therefore blocked from contact with electrolyte by the flow-optimized negative electrode spacer 200. For example, a distance between adjacent pegs 204 along the x-axis may be similar to a distance between adjacent pegs 204 along the z-axis. Details of the flow-optimized electrode negative spacer are shown with greater clarity in FIG. 3, corresponding to dashed area 208 indicated in FIG. 2.

The pegs 204 may be oriented such that a central axis of rotation 302 of each of the pegs 204 is aligned parallel with the y-axis. A planar face at an end of each of the pegs 204 may be in face-sharing contact with and attached to the surface of the bipolar plate 202. The pegs 204 may have a uniform height 304, defined along the y-axis, which may be selected to provide a target available surface area of the flow-optimized negative electrode spacer 200, in addition to the active area 206 (as indicated in FIG. 2) of the bipolar plate 202, for plating of a metal during charging of the redox flow battery system. For example, the height 304 of the pegs 204 may vary depending on a desired amount of plating and flow volume. Increases in plating area and flow volume provided by increasing the height 304 may be balanced by an associated increase in overall electrical resistance of a corresponding battery cell, however, due to an increase in a flow path length across the bipolar plate 202.

In one example, the height 304 of the pegs 204 (or of any of the examples of negative electrode spacers provided herein) may be 2.8 mm, which may enable a plating thickness of 1 mm. In other words, 1 mm of the 2.8 mm height may be occupied by plated metal. A remaining amount of space (e.g., 1.8 mm along the height 304 of the pegs 204) may provide a gap between a membrane (e.g., membrane separator) and the plated metal, thereby allowing electrolyte to flow through the active area of the bipolar plate 202.

The height 304 of the pegs 204 may be in a range of 0.5 mm to 6 mm. In some examples, depending on a tolerance for resistance and product efficiency demands, pegs with heights of greater than 6 mm may be used. Shorter peg heights may enable lower internal resistance, and therefore more desirable voltaic efficiencies, but lower discharge capacities (e.g., less plating), while taller peg heights may allow for higher discharge capacities (e.g., more plating) but lower voltaic efficiencies.

A diameter 306 of the pegs 204 may be selected, along with the height 304 of the pegs, to provide the target available surface area of the flow-optimized negative electrode spacer 200 while maximizing the active area 206 of the bipolar plate 202. In one example, the diameter 306 may be 2 mm. In other examples, the diameter 306 may be in a range of 1-20 mm. Further, by maintaining the height 304 uniform amongst the pegs 204, a membrane separator, coupled to ends of the pegs opposite of the bipolar plate 202, may be maintained a uniform distance away from the bipolar plate 202.

A spacing of the pegs 204 may also be selected to balance a desired size of the active area 206 of the bipolar plate 202 with an ability of the flow-optimized negative electrode spacer 200 to support the membrane separator, as shown in FIG. 4 and described further below, which may be formed of a more flexible material than either of the bipolar plate 202 or the flow-optimized negative electrode spacer 200. For example, the pegs 204 may extend, along the y-axis, between the bipolar plate 202 and a membrane separator in contact with ends of the pegs opposite of the bipolar plate 202. The spacing of the pegs 204 may therefore be sufficiently dense to circumvent contact between the membrane separator and the bipolar plate 202. As indicated in FIG. 3, a first distance 308 between the pegs 204 along the z-axis may be similar to a second distance 310 between the pegs 204 along the x-axis, where the distances may be, in one example, 7.5 mm. In other examples, however, the distances may be in a range of 2.5 mm to 12.5 mm. Furthermore, in some examples, the first distance 308 may not be equal to the second distance 310, and may instead be smaller or larger than the second distance 310.

An effect of varying the peg diameter, e.g., the diameter 306 of FIG. 3, on peg spacing for a given area for plating is shown in FIG. 9 in a graph 900. The graph 900 includes a plurality of plots 902, each of which represents a specific peg spacing (or pitch) in mm. The peg spacing depicted by the plurality of plots 902 increases according to arrow 904 and an open area of the negative electrode (e.g., of available plating area at an active area of a bipolar plate) is indicated by dashed line 906. As peg spacing increases, the corresponding peg diameter that maximizes the open area (e.g., achieves the open area indicated by dashed line 906) also increases. The relationship shown in the graph 900 between the peg spacing and the peg diameter may represent a tradeoff between maximizing plating area and providing sufficient support to a membrane separator to mitigate defection of the membrane separator into the active area for plating at the bipolar plate.

As an example, decreasing the peg spacing (or spacing between any other embodiments of the negative electrode spacer) may increase support of the membrane separator while achieving a desired plating volume. By increasing the open area, however, power density may be enhanced by enabling more plating in the active area. In order to provide an optimal balance, a peg diameter may be initially selected, such 6 mm, with a suitable peg spacing, such as 7.5 mm spacing. The open area may then be maximized by adjusting the peg spacing and varying the peg diameter while monitoring deflection of the membrane separator.

The cylindrical geometry of the pegs 204 allows an area of the bipolar plate surface occupied by each of the pegs 204, the area corresponding to a circular cross-section of the pegs 204, to be reduced relative to a negative electrode spacer comprising ribs. As an exemplary comparison, for a negative electrode spacer with ribs where the ribs have a width of 1.2 mm and a spacing of 7.5 mm, the bipolar plate active area may be 84% of a total surface area of the bipolar plate 202. In contrast, when the flow-optimized negative electrode spacer 200 includes the pegs 204 with the diameter 306 of 2 mm and a spacing of 7.5 mm (e.g., where both the first distance 308 and the second distance 310 are 7.5 mm), the bipolar plate active area may be 96% of the total surface area of the bipolar plate 202. Correspondingly, an area occupied by the flow-optimized negative electrode spacer 200 may be 4% of the active of bipolar plate 202. In other examples, the area occupied by the flow-optimized negative electrode spacer 200 relative to the active area of the bipolar plate 202 may be less than 10%, or less than 5%. A smaller cumulative area occupied by the pegs 204 relative to the ribs may allow more of the surface of the bipolar plate 202 to be available for directing fluid flow through the negative electrode compartment, for separating gases from the fluid flow, and for heat distribution. Furthermore, by spacing the pegs apart along the x-axis, in addition to the z-axis, electrolyte may flow across the bipolar plate in more than one direction.

For example, while the predominant direction of electrolyte flow, as indicated by arrows 203 in FIG. 2, may be aligned with the z-axis, turbulence created by friction between the electrolyte flow and surface of the pegs 204 may drive flow in a perpendicular direction, e.g., laterally, across the bipolar plate 202. The predominant direction of electrolyte flow may correspond to a direction of electrolyte flow between one or more inlets of the negative electrode compartment and one or more outlet of the negative electrode compartment. Electrolyte flow may be distributed homogeneously through the negative electrode compartment by enabling lateral mixing of the electrolyte as the electrolyte flows along the predominant flow direction. The mixing of the electrolyte may result in more uniform plating across surfaces of the negative electrode compartment, thereby enabling higher resistance of plated metal to cracking and flaking and maximizing a power output of the redox flow battery system in a consistent manner.

The flow-optimized negative electrode spacer 200 and the bipolar plate 202 may be included in a membrane electrode assembly (MEA) 400, as illustrated in FIG. 4. The MEA 400 may be an example of a repeating unit in a battery stack of the redox flow battery system. For example, additional MEAs may be stacked above and below the MEA 400 along the y-axis in the battery stack. The MEA 400 further includes a membrane separator 402 coupled to ends of the pegs 204 of the flow-optimized negative electrode spacer 200, opposite of the bipolar plate 202, and a positive electrode 404 coupled to a surface of the bipolar plate 202, opposite of the flow-optimized negative electrode spacer 200. Support structures 406, such as frame plates, may also be incorporated into the MEA 400 to provide structural support to the MEA 400.

A negative electrode compartment 401 of the MEA 400 may be formed between the membrane separator 402 and the bipolar plate 202. A positive electrode compartment 403 (shown partially in FIG. 4) may be arranged below the negative electrode compartment 401, relative to the y-axis, which may be formed between the bipolar plate 202 and another membrane separator coupled to a surface of the positive electrode 404, opposite of the bipolar plate 202. The positive electrode 404 may therefore occupy a volume of the positive electrode compartment 403. A predominant direction of electrolyte flow through the negative electrode compartment 401 is indicated by arrow 405. As an example, electrolyte may enter the negative electrode compartment 401 through one or more inlets arranged in one of the support structures 406 framing the bipolar plate 202 and may exit the negative electrode compartment 401 through one or more outlets of the respective support structure, the one of more outlets located at an opposite end of the bipolar plate 202 from the one or more inlets.

The flow-optimized negative electrode spacer 200 may maintain a uniform space 408 between the membrane separator 402 and the bipolar plate 202 across the active area of the bipolar plate 202. In some examples, the spacing between the pegs 204 of the flow-optimized negative electrode spacer 200 may be adjusted according to a flexibility of the membrane separator 402. For example, the spacing between the pegs 204 may be decreased for a more flexible membrane separator compared to a less flexible (e.g., more rigid) membrane separator. Further, when the spacing between the pegs 204 is decreased, the diameter of the pegs 204 may also be decreased in order to maintain a desired flow volume within the negative electrode compartment 401.

The cylindrical geometry of the flow-optimized negative electrode spacer 200 of FIGS. 2-4 may present one option out of various possible shapes for enhancing flow distribution and maintaining a desired flow volume in the negative electrode compartment. A second example of a flow-optimized negative electrode spacer 500 is depicted in FIG. 5 coupled to the bipolar plate 202 of FIGS. 2-4. The active area 206 of the bipolar plate 202 is defined by a positioning of pegs 502 of the flow-optimized negative electrode spacer 500, where the pegs 502 may have an oblong cross-sectional geometry along the x-z plane.

The pegs 502 may be arranged in sets of columns 504 along a direction of predominant electrolyte flow, as indicated by arrows 506, across the bipolar plate 202, where the direction of predominant electrolyte flow is parallel with the z-axis and each of the sets of columns 504 may include two columns. The sets of columns 504 may be similarly configured across the bipolar plate 202, along the x-axis. For example, a first set of columns 504a of the sets of columns 504 includes a pair of adjacently positioned columns of the pegs 502 extending across the active area 206 of the bipolar plate 202 along the z-axis. The pegs 502 of the respective columns may not be aligned along the x-axis. Instead, the pegs 502 of the pair of adjacently positioned columns may be laterally offset relative to one another while maintaining a uniform distancing between the adjacently positioned columns as well as between the pegs 502 within a respective column of the first set of columns 504a.

In addition, a distance between the adjacently positioned columns of the first set of columns 504a may be different than a distance between adjacent sets of the columns 504. In other examples, the distance between the adjacently positioned columns, as well as a distance between pegs of each set of columns, may vary from the spacing shown in FIG. 5 in various ways, without departing from the scope of the present disclosure. As depicted in FIG. 5, a first distance 602 between adjacent (but offset) pegs 502 of the first set of columns 504a is smaller than a second distance 604 between the first set of columns 504a and a second set of columns 504a, the second set of columns 504b arranged beside the first set of columns 504a along the x-axis. The second distance 604 may be measured as a lateral distance between a rightmost peg of the first set of columns 504a and a leftmost peg of the second set of columns 504b along the x-axis.

For example, a detailed view of a portion of the flow-optimized negative electrode spacer 500 (and of the bipolar plate 202), indicated by dashed area 508 in FIG. 5, is shown in FIG. 6. Therein, the pegs 502 are depicted with a longitudinal axis 601 (e.g., an axis corresponding to a longest dimension of the pegs 502) of each peg aligned with the z-axis. In one example, a width of the pegs 502 may be 2 mm, the width defined along the x-axis, and a length of the pegs 502, the length defined along the longitudinal axis 601, may be 6 mm. In other examples, the width may be between 2 mm to 13 mm and the length may be between 2.5 mm to 10 mm.

An effect of varying a width and a length of non-circular pegs, such as the pegs 502 of FIG. 5, on an open area of a bipolar plate is depicted in FIG. 10 in a graph 1000. The open area may vary based on an overall area of the bipolar plate and a number of pegs to be included in a negative electrode spacer. As shown in FIG. 10, the graph 1000 includes a plurality of plots 1002, each plot representing a specific peg length in mm. The plurality of plots 1002 increase in peg length according to arrow 1004 and a target open area of the bipolar plate is indicated by dashed line 1006. The graph 1000 indicates that shorter peg length corresponds to larger open areas for a given peg width.

Optimization of the peg length and width to achieve a maximum open area while providing sufficient support to a membrane separator may be enabled as described above, with reference to FIG. 9. For example, a target open area of 84% and spacing of 7.5 mm may be initially set and the peg widths and lengths may be varied to increase the open area. Based on the plurality of plots 1002 of FIG. 10, a peg length of between 2.5 mm to 7.5 mm and a peg width less than 12 mm may be desirable.

As described above, a height 606 of the pegs 502 may at least partially determine a plating surface capacity of the flow-optimized negative electrode spacer 500. The oblong geometry of the pegs 502 may increase electrolyte flow along the z-axis, relative to the cylindrical pegs 204 of FIGS. 2-4, while staggering of the pegs 502 along the x-axis may promote lateral electrolyte flow. Furthermore, a difference between the first distance 602 and the second distance 604 may effect different rates (e.g., speeds) of electrolyte flow through the adjacently positioned columns of each of the sets of columns 504 versus between adjacent sets of columns. The different electrolyte flow speeds across the bipolar plate 202 may further increase turbulence, mixing, and homogeneous electrolyte distribution. A spacing of the pegs 502, e.g., values of the first distance 602 and the second distance 604, as well as the height 606 of the pegs 502 may be balanced to provide a target active area of the bipolar plate 202, a target plating surface area, and a desired flow volume of a corresponding negative electrode compartment.

A third example of a flow-optimized negative electrode spacer 700 is illustrated in FIG. 7. The flow-optimized negative electrode spacer 700 is coupled to the bipolar plate 202 of FIGS. 2-6. The flow-optimized negative electrode spacer 700 may include pegs 702 which may be similarly shaped as the pegs 502 of FIGS. 5-6. For example, the pegs 702 may have a similar oblong cross-sectional geometry along the x-z plane and may have similar dimensions as the pegs 502 of FIGS. 5-6. The pegs 702 may also be arranged in set of columns 704, where the columns extend along the z-axis, parallel with a direction of predominant electrolyte flow, as indicated by arrows 706. Each of the sets of columns 704 may include two adjacently positioned, parallel columns of the pegs 702.

An orientation of the pegs 702, however, may not be aligned parallel with one another. Instead, laterally adjacent pegs 702 of each of the sets of columns 704 may be angled relative to one another to form a V-shape. Within a given set of columns of the pegs 702, the V-shape of the pegs 702 may funnel electrolyte flow such that lateral flow, e.g., flow along the x-axis, is increased relative to the examples of FIGS. 2-6. Turbulent flow may further be promoted by varying a spacing between the columns of the pegs. For example, as described above with reference to FIGS. 5-6, a lateral distance between adjacent pegs within a first set of columns 704a of the sets of columns 704, may be smaller than a lateral distance between the first set of columns 704a and a second set of columns 704b arranged laterally adjacent to the first set of columns 704a. The lateral distance between adjacent pegs within a given column may be measured between ends of the pegs 702 forming an apex of the V-shape. The lateral distance between the first set of columns 704a and the second set of columns 704b may be measured from a rightmost end of a rightmost peg of the first set of columns 704a and a leftmost end of a leftmost peg of the second set of columns 704b.

The flow-optimized negative electrode spacer (e.g., any of the flow-optimized negative electrode spacers depicted in FIGS. 2-7), may be coupled to the bipolar plate via a fabrication technique that allows the flow-optimized negative electrode spacer configuration to be selected and adjusted as desired. For example, the flow-optimized negative electrode spacer may be 3D printed directly onto the surface of the bipolar plate, leveraging a compatibility between materials of the bipolar plate and the flow-optimized negative electrode spacer to enable facile bonding therebetween. Parameters of the 3D printing, such as spacing of the pegs, alignments of the pegs, dimensions of the pegs, surface texture of the pegs, etc., may be selected by an operator and thereby customized according to operating targets of a specific redox flow battery system.

Further, it will be appreciated that the examples of the flow-optimized negative electrode spacer are non-limiting examples. Various combinations of the features shown in the individual examples are possible without departing from the scope of the present disclosure. For example, the spacing between the pegs may vary from that shown in the examples, the flow-optimized negative electrode spacer may incorporate more than one shape of the pegs, and other modifications to the flow-optimized negative electrode spacer may be readily achieved by the methods described herein to provide a desired effect on electrolyte distribution in the negative electrode compartment.

An example of a method 800 for manufacturing a MEA, including a flow-optimized negative electrode spacer, is shown in FIG. 8. The flow-optimized negative electrode spacer may be any of the examples illustrated in FIGS. 2-7. The method may be executed by various manufacturing equipment, including but not limited to an extruder, an injection molding system, a 3D printer, a heat source, etc. Manufacturing steps included in the method and performed by the manufacturing equipment may be conducted along an assembly line that enables sequential execution of the manufacturing steps. In one example, the MEA may be configured for installation in a redox flow battery system, such as an IFB.

At 802, the method includes forming a bipolar plate. In one example, the bipolar plate may comprise graphite loaded with polypropylene which may be extruded as a sheet. In another example, the bipolar plate may be formed by injection molding. The flow-optimized negative electrode spacer may be 3D printed directly onto a surface of the bipolar plate at 804, where pegs of the flow-optimized negative electrode spacer may be formed of polypropylene. For example, the extruded bipolar plate may be immediately delivered to the 3D printer, which may be located after the extruder in the assembly line.

As an example, an operator may enter printing parameters into a user interface of a controller, e.g., processor, of the 3D printer. For example, a number of pegs, an overall configuration of an array of the pegs forming the flow-optimized negative electrode spacer, and a geometry and dimensions of the pegs, may be input to the controller. A 3D printing head of the 3D printer may include, in one example, multiple nozzles such that the pegs may be extruded in one operating cycle of the 3D printer. In other examples, the 3D printing head may include a lesser quantity of nozzles that demands more than one operating cycle of the 3D printing to extrude all the pegs of the flow-optimized negative electrode spacer. A speed of printing, according to number of nozzles, may therefore be selected based on a desired balance between cost and efficiency.

It will be appreciated that 3D printing of the flow-optimized negative electrode spacer is a non-limiting example of how the flow-optimized negative electrode spacer may be directly coupled to the bipolar plate surface. Other techniques have been contemplated, including welding the flow-optimized electrode spacer using a hot plate, a laser, friction, or other plastic welding fabrication techniques, and two-shot injection molding where a conductive bipolar plate is molded during a first shot and non-conductive pegs of the flow-optimized negative electrode spacer may be molded in a second shot, with a timing of the shots relative to one another being variable. Other examples for coupling the flow-optimized negative electrode spacer to the bipolar plate include co-extrusion of the pegs with the bipolar plate, adherence with epoxy along with a suitable surface treatment (such as plasma) of the flow-optimized negative electrode spacer and the bipolar plate. As yet another example, the pegs of the flow-optimized negative electrode spacer may be adhered to the bipolar plate using a suitable adhesive, such as epoxy.

In some examples, printing the flow-optimized negative electrode spacer onto the bipolar plate may include heating the surface of the bipolar plate prior to 3D printing. For example, by positioning the 3D printer immediately after the extruder, the bipolar plate may still at elevated temperature and at least partially molten when the bipolar plate reaches the 3D printer. As the pegs may be formed of the same or a similar thermoplastic polymer as the bipolar plate, the pegs may readily bond to the at least partially molten thermoplastic polymer of the bipolar plate. Upon cooling of the bipolar plate and flow-optimized negative electrode spacer after 3D printing of the pegs, the flow-optimized negative electrode spacer may be attached, e.g., adhered, to the surface of the bipolar plate. In other examples, a heat source may be located between the extruder and the 3D printer to heat the surface of the bipolar plate prior to 3D printing to ensure that the bipolar surface is at least partially molten.

At 806, the method includes coupling other components, such as a positive electrode and a membrane separator, to the bipolar plate with the flow-optimized negative electrode spacer bonded thereto. As an example, the positive electrode may be previously fabricated felt and the membrane separator may be a previously extruded membrane material and the components may be added to the assembly to layer the components over the bipolar plate and the flow-optimized negative electrode spacer accordingly, to form a stack. For example, the components may be fed to the assembly line concurrently in an automated manner, or may be individually added to the assembly line.

At 808, the stack (e.g., the positive electrode, the bipolar plate, the flow-optimized negative electrode spacer, and the membrane separator) may be cut according to target dimensions of the MEA. The target dimension may be determined based on a size of a power module of the redox flow battery system and/or a size of supporting components, such as frame plates, for the MEA. In some instances, the bipolar plate and the flow-optimized negative electrode spacer may be cut to the target dimensions prior to coupling of the remaining components of the MEA thereto. For example, coupling of the remaining components at 806 and cutting of the stack at 808 may be reversed in order. As an example, the felt of the positive electrode and the membrane material of the membrane separator may be independently cut to the target dimensions prior to coupling to the bipolar plate with the flow-optimized negative electrode spacer. The supporting components may be added to the layers of the stack before or after the layers are combined into the stack. The stack may therefore be formed already having the target dimensions.

In this way, a negative electrode spacer may be configured to optimize electrolyte flow and distribution through a negative electrode compartment of a battery system. The negative electrode spacer (e.g., a flow-optimized negative electrode spacer), may be directly coupled and attached to a surface of the bipolar plate. By integrating the negative electrode spacer into the surface of the bipolar plate, precluding layering the negative electrode spacer onto the bipolar plate as a separate, independent layer of a MEA, a range of possible geometries for the negative electrode spacer may be expanded. The negative electrode spacer may be a plurality of pegs protruding from the surface of the bipolar plate, obviating reliance on an independent structural stability of the negative electrode spacer that may otherwise be demanded when the negative electrode spacer is a standalone structure. As such the negative electrode spacer may be formed of discrete units that are not interconnected other than by coupling of each of the discrete units to the bipolar plate surface. Greater flexibility and customization of the negative electrode spacer configuration may be provided by the examples and methods described above, enabling plating homogeneity to be increased during battery system charging. A power output of the battery system may therefore be increased and maintained consistent over a useful of the battery system while reducing costs and materials associated with manufacturing.

FIGS. 2-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-7 are drawn approximately to scale, although other dimensions or relative dimensions may be used.

The disclosure provides support for an electrode assembly for a battery system including a bipolar plate and a negative electrode spacer fixedly coupled to a surface of the bipolar plate, the negative electrode spacer comprising an array of discrete structures protruding from the surface of the bipolar plate. A first example of the electrode assembly further includes where the bipolar plate is formed of a composite of a thermoplastic polymer and a conductive material and the negative electrode spacer is formed of the thermoplastic polymer. A second example of the electrode assembly, optionally including the first example, further includes where the negative electrode spacer is one of additively manufactured or welded directly onto the surface of the bipolar plate. A third example of the electrode assembly, optionally including one or more of the previous examples, further includes where the array of discrete structures is spaced apart from one another along a first axis and a second axis of the bipolar plate, the first axis parallel with a direction of predominant electrolyte flow across the bipolar plate and the second axis perpendicular to the first axis, and wherein the array of discrete structures is not mechanically coupled to one another. A fourth example of the electrode assembly, optionally including one or more of the previous examples, further includes where electrolyte flows between the array of discrete structures along both the first axis and the second axis. A fifth example of the electrode assembly, optionally including one or more of the previous examples, further includes where a portion of an active area of the bipolar plate occupied by the array of discrete structures is less than 10%. A sixth example of the electrode assembly, optionally including one or more of the previous examples, further includes where the array of discrete structures has a uniform height. A seventh example of the electrode assembly, optionally including one or more of the previous examples, further includes where the array of discrete structures extends between the surface of the bipolar plate and a membrane separator of the electrode assembly, and wherein the membrane separator is maintained a uniform distance away from the surface of the bipolar plate by the array of discrete structures.

The disclosure provides additional support for a method for manufacturing an electrode assembly including forming a bipolar plate from a composite of a conductive material and thermoplastic polymer and fixedly coupling a negative electrode spacer to the bipolar plate, the negative electrode spacer formed of the thermoplastic polymer and configured as a plurality of pegs bonded to a surface of the bipolar plate. A first example of the method further includes where fixedly coupling the negative electrode spacer to the bipolar plate includes 3D printing the negative electrode spacer onto the surface of the bipolar plate. A second example of the method, optionally including the first example, further includes where the negative electrode spacer is 3D printed onto the bipolar plate while the bipolar plate is at least partially molten. A third example of the method, optionally including one or more of the previous examples, further includes where the negative electrode spacer is 3D printed using a 3D printing head with multiple nozzles, and wherein the negative electrode spacer is 3D printed within one printing cycle of the 3D printing head. A fourth example of the method, optionally including one or more of the previous examples, further includes where the bipolar plate is extruded and the negative electrode spacer is fixedly coupled to the bipolar plate before the bipolar plate cools and solidifies. A fifth example of the method, optionally including one or more of the previous examples, further includes where the plurality of pegs are discrete structures coupled at a first end to the bipolar plate and in contact with a membrane separator at a second end of the discrete structures, the second end opposite of the first end.

The disclosure provides further support for a negative electrode spacer, including a plurality of pegs, spaced apart from one another along a surface of a bipolar plate and without mechanical connections therebetween, the plurality of pegs configured to promote lateral flow of electrolyte along a first direction perpendicular to a predominant electrolyte flow across the surface, in addition to the predominant electrolyte flow. A first example of the negative electrode spacer further includes where the plurality of pegs has one or more of a circular cross-sectional geometry and an oblong cross-sectional geometry along a plane parallel with the surface of the bipolar plate. A second example of the negative electrode spacer, optionally including the first example, further includes where the plurality of pegs is uniformly spaced apart along the first direction and a second direction, the second direction perpendicular to the first direction and parallel with the predominant electrolyte flow. A third example of the negative electrode spacer, optionally including one or more of the previous examples, further includes where the plurality of pegs is spaced apart along the first direction by a first distance and spaced apart along a second direction by a second distance, the second direction perpendicular to the first direction and parallel with the predominant electrolyte flow and the second distance different from the first distance. A fourth example of the negative electrode spacer, optionally including one or more of the previous examples, further includes where each peg of the plurality of pegs is aligned with adjacent pegs along the first direction or offset from the adjacent pegs along the first direction. A fifth example of the negative electrode spacer, optionally including one or more of the previous examples, further includes where the plurality of pegs is arranged in pairs of pegs, and wherein each pair of pegs forms a V-shape.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electrode assembly for a battery system, comprising:
a bipolar plate; and
a negative electrode spacer fixedly coupled to a surface of the bipolar plate, the negative electrode spacer comprising an array of discrete structures protruding from the surface of the bipolar plate.

2. The electrode assembly of claim 1, wherein the bipolar plate is formed of a composite of a thermoplastic polymer and a conductive material and the negative electrode spacer is formed of the thermoplastic polymer.

3. The electrode assembly of claim 1, wherein the negative electrode spacer is one of additively manufactured or welded directly onto the surface of the bipolar plate.

4. The electrode assembly of claim 1, wherein the array of discrete structures is spaced apart from one another along a first axis and a second axis of the bipolar plate, the first axis parallel with a direction of predominant electrolyte flow across the bipolar plate and the second axis perpendicular to the first axis, and wherein the array of discrete structures is not mechanically coupled to one another.

5. The electrode assembly of claim 4, wherein electrolyte flows between the array of discrete structures along both the first axis and the second axis.

6. The electrode assembly of claim 1, wherein a portion of an active area of the bipolar plate occupied by the array of discrete structures is less than 10%.

7. The electrode assembly of claim 1, wherein the array of discrete structures has a uniform height.

8. The electrode assembly of claim 1, wherein the array of discrete structures extends between the surface of the bipolar plate and a membrane separator of the electrode assembly, and wherein the membrane separator is maintained a uniform distance away from the surface of the bipolar plate by the array of discrete structures.

9. A method for manufacturing an electrode assembly, comprising:
forming a bipolar plate from a composite of a conductive material and thermoplastic polymer; and
fixedly coupling a negative electrode spacer to the bipolar plate, the negative electrode spacer formed of the thermoplastic polymer and configured as a plurality of pegs bonded to a surface of the bipolar plate.

10. The method of claim 9, wherein fixedly coupling the negative electrode spacer to the bipolar plate includes 3D printing the negative electrode spacer onto the surface of the bipolar plate.

11. The method of claim 10, wherein the negative electrode spacer is 3D printed onto the bipolar plate while the bipolar plate is at least partially molten.

12. The method of claim 10, wherein the negative electrode spacer is 3D printed using a 3D printing head with multiple nozzles, and wherein the negative electrode spacer is 3D printed within one printing cycle of the 3D printing head.

13. The method of claim 9, wherein the bipolar plate is extruded and the negative electrode spacer is fixedly coupled to the bipolar plate before the bipolar plate cools and solidifies.

14. The method of claim 9, wherein the plurality of pegs are discrete structures coupled at a first end to the bipolar plate and in contact with a membrane separator at a second end of the discrete structures, the second end opposite of the first end.

15. A negative electrode spacer, comprising:
a plurality of pegs, spaced apart from one another along a surface of a bipolar plate and without mechanical connections therebetween, the plurality of pegs configured to promote lateral flow of electrolyte along a first direction perpendicular to a predominant electrolyte flow across the surface, in addition to the predominant electrolyte flow.

16. The negative electrode spacer of claim 15, wherein the plurality of pegs has one or more of a circular cross-sectional geometry and an oblong cross-sectional geometry along a plane parallel with the surface of the bipolar plate.

17. The negative electrode spacer of claim 15, wherein the plurality of pegs is uniformly spaced apart along the first direction and a second direction, the second direction perpendicular to the first direction and parallel with the predominant electrolyte flow.

18. The negative electrode spacer of claim 15, wherein the plurality of pegs is spaced apart along the first direction by a first distance and spaced apart along a second direction by a second distance, the second direction perpendicular to the first direction and parallel with the predominant electrolyte flow and the second distance different from the first distance.

19. The negative electrode spacer of claim 15, wherein each peg of the plurality of pegs is aligned with adjacent pegs along the first direction or offset from the adjacent pegs along the first direction.

20. The negative electrode spacer of claim 15, wherein the plurality of pegs is arranged in pairs of pegs, and wherein each pair of pegs forms a V-shape.
